(19) United States
(12) Patent Application Publication
(10) Pub. No.: US 2024/0292863 A1
(43) Pub. Date: Sep. 5, 2024

(54) RAPESEED PROTEIN COMPOSITION

(71) Applicant: DSM IP ASSETS B.V., Heerlen (NL)

(72) Inventors: Johanna Corline Margriet VINK, Echt (NL); Arjen SEIN, Echt (NL)

(21) Appl. No.: 18/256,820

(22) PCT Filed: Dec. 17, 2021
(86) PCT No.: PCT/EP2021/086485

§ 371 Date: Jun. 9, 2023

(30) Foreign Application Priority Data
Dec. 18, 2020 (EP) 20215534.7

(51) Int. Cl. A23G 9/38; A23D 7/005; A23G 9/34; A23J 3/14; A23L 9/20; A23P 30/40

(52) U.S. Cl. CPC A23G 9/38; A23D 7/0053; A23G 9/34; A23J 3/14; A23L 9/24; A23P 30/40

(57) ABSTRACT

The present invention relates to a composition comprising rapeseed protein, a vegetable fat having a solid fat content of 20-90% (w/w) at 5° C., sucrose and water, wherein the amount of rapeseed protein is from 0.1-10% (w/w), wherein the amount of vegetable fat is from 1-40% (w/w) and wherein the amount of sucrose is from 1-25% (w/w).

### CROSS REFERENCE TO RELATED APPLICATIONS

This application is the National Stage entry of International Application No. PCT/EP2021/086485, filed 17 Dec. 2021, which claims priority to European Patent Application No. 20215534.7, filed 18 Dec. 2020.

### BACKGROUND

### Field

The present invention is directed to a composition comprising rapeseed protein, a vegetable fat and sucrose, and to the use of such composition in food products such as an ice cream or a whipping cream. Further the present invention relates to a method for the preparation of the composition.

### Description of Related Art

Food products comprising plant proteins as alternative to animal-derived proteins nowadays receive attention because of consumer concerns about the environmental impact of animal-based products and the beneficial nutritional characteristics of plant-based foods. In particular, products based on plant proteins as alternative to dairy products such as milk, yoghurt cheese, cream cheese, fresh cheese, ice cream or whipping cream have gained popularity.

Plant proteins may be derived from a variety of legumes and pulses such as soybean, pea, chickpea, fava bean, lentil, mung bean, peanut, lupin; oil seeds/cabbages such as rapeseed or canola, sunflower, camelina, sesame; cereals and pseudo cereals, such as wheat, barley, oat, rice, sorghum, quinoa, buckwheat; nuts, such as almond, hazelnut, walnut, cashew; coconut; nightshades such as potato.

Use of plant proteins in food products with a high water content, such as beverages, creams and ice cream premixes, can lead to physio-chemical instability issues such as protein sedimentation or precipitation of protein aggregates and creaming and even coalescence of oil/fat droplets. This occurs particularly upon heat treatment such as is necessary in order to pasteurize or sterilize the product to increase its shelf life.

The instant invention is concerned with food products such as an ice cream or a whipping cream comprising a particular plant protein, rapeseed protein. Products such as ice cream or whipping cream are characterized by a composition of at least a protein, a partially crystalline fat, and optionally hydrocolloids, emulsifiers, sugars and other carbohydrates.

Such composition is prepared by combining the ingredients in an aqueous phase, shearing this into a dispersion, subjecting this mix to a heat treatment, such as pasteurization, to obtain a microbiologically safe product, subsequently to a high shear treatment, usually a high-pressure homogenization step, and bringing the premix to a temperature between 0 and 20° C. to ripen. For an ice cream type of product, the dispersion is frozen while whipping/introducing and dispersing air, the freshly frozen product is consumed as such (soft serve) or is further deep frozen to fully settle the structure and to be stored until consumption. A whipping cream can be whipped after the ripening phase to obtain a stable aerated cream.

Unfortunately, the plant protein extracted from rapeseed is no exception to the problems outlined above, i.e. aggregation and/or sedimentation can occur under certain circumstances used during the production of the ice cream or whipping cream premix. Such dispersions require a pasteurization during the production stage, which usually occurs before the high shear treatment step. A problem associated with the use of rapeseed protein in such premixes is that aggregation of plant protein occurs during treatment at elevated temperatures, before being subjected to high-shear treatment.

Soy protein is most commonly used as plant protein source in aerated food products. However, soy is allergenic, and thus there is a need in the art for alternative solutions to provide ice cream or whipping cream.

As alternative to soy protein often pea protein isolate is used, but next to off-flavour issues, also functional properties such as emulsification and aeration may also be insufficient.

Another aspect is the off flavour generated in many plant-protein-containing ice cream or frozen products. Products based on pea protein isolate for instance may be prone to off flavours. Rapeseed protein as such may also have an outspoken taste.

WO2017/001266 relates to a frozen confection comprising triglyceride fat and 1.5 wt % or less of total protein, wherein between 25 and 100% protein of the total protein is from one or more vegetable sources. Further is disclosed that the emulsion droplet size has a D50 of greater than 0.2 and less than 1.19 μm, and especially less than 1.16 show a good microstructure.

A problem with rapeseed is that the emulsion droplet size distribution and median size are too large for a premix that is suitable for the manufacture of ice cream or whipped cream.

There is therefore a need for a food composition comprising rapeseed protein that does not lead to any or all of the problems mentioned above and that is stable in the common process towards an ice cream or a whipping cream containing rapeseed protein.

### DETAILED DESCRIPTION OF THE INVENTION

By the expression “a hydrocolloid” is to be understood a type of hydrocolloid. By the expression “a vegetable oil” is to be understood a type of vegetable oil or fat. By the expression “an emulsifier” is to be understood a type of emulsifier.

As used herein, all the percentages are by weight (wt %) of the total weight of the composition, unless expressed otherwise. All ratios expressed herein are on a weight/weight (w/w) basis, unless expressed otherwise.

Ice cream or frozen confectionary product or frozen dessert, are to be considered all the same in this context. The process of making dairy-based ice cream and the role the various ingredients have are well described in the literature, such as in “Ice Cream, Sixth Edition” by R. T Marshall, H. D. Goff and R. W. Hartel, Springer Science+Business Media, New York USA, 2003. The process and composition need to be balanced to come to high quality ice cream. Traditional ice cream contains milk protein or non-fat milk solids (protein, lactose, minerals), milk fat, sweeteners, mostly sucrose and often maltodextrins, stabilizers (hydrocolloids), and emulsifiers. To produce ice cream, commonly a premix is made from these ingredients, an oil-in-water emulsion, that is subsequently pasteurized (for shelf life, and also to prevent microbial outgrowth during the ripening phase), high-shear treated (often by using a high-pressure homogenizer), cooled to ripening temperature, between 0 and 20° C., and left to ripen for a certain amount of time to allow the fat phase to recrystallize such that upon whipping, the fat globules can partially coalesce to form a firm skeleton. This ripened premix is then frozen under high-shear conditions that enables entrainment of air. Usually specially designed equipment is used, such as a scraped-surface freezer. The frozen product can be consumed directly as ‘soft serve’ ice cream, or frozen more deeply for longer storage and consumption as harder ice cream.

In a changing world with high need for vegan products based on non-animal ingredients, the milk components can be replaced by vegetable-based components, using plant-based protein and plant-based oils and fats. However, the production of such plant-based ice cream is not straightforward, for instance the stability of the premix towards required heat treatment (pasteurization) and to sedimentation or creaming occurring in the ripening phase, or the subtle balance between emulsion stability and the right level of coalescence during the whipping/freezing step, or the stability of the frozen product. Furthermore, the taste and mouthfeel properties of the final product is also influenced by changing to a full plant-based product.

Whipping cream is similar as ice cream traditionally made from dairy ingredients. Dairy cream specifically is made from milk, by separating the cream fraction from milk and rebalancing the product to the proper fat and protein amounts with milk or other milk-derived streams. Usually the fat content of whipping creams is with 15-40% higher than for ice cream, 0.5-15%. In commercial products often some hydrocolloid such as carrageenan is added to reduce drainage of serum from the whipped cream. Upon whipping, air can be incorporated, that initially leads to a foam where air cells are stabilized by a protein film, leading to a weak, soft foam-like product. Upon further whipping, the oil droplets partially coalesce and form a skeleton around air cells, giving the whipped cream its stability and macroscopic firmness. Whipping products can also be made by combining milk or butter milk, milk protein and/or non-fat milk solids (such as skimmed milk powder, butter milk powder), with fat—either animal or vegetable based or mixtures—and other ingredients like emulsifiers, hydrocolloids (such as locust bean gum, guar gum, carrageenan, xanthan gum etcetera), fillers, colorants, flavour, and producing a stable oil-in-water emulsion from this. Whipping creams can be pasteurized for short or medium shelf life products, or alternatively sterilized or UHT treated (Ultra High Temperature) for long shelf life products, by methods known in the art. Before whipping, the product should be kept cool (<10° C.) for at least one hour to optimize the whipping process.

A vegan version of such a product suffers from the same difficulties as a vegan ice cream: stability of premix against heat treatment (pasteurization or even UHT, ultra-high temperature treatment), stability during storage and ripening, and good whipping, stable whipped product of proper specific volume, lack of serum leakage.

In a first aspect, the present invention relates to a composition, preferably suitable for the manufacture of ice cream and whipped cream, comprising rapeseed protein, a vegetable fat having a solid fat content of 20-90% (w/w) at 5° C., sucrose and/or water, wherein the amount of rapeseed protein is from 0.1-10% (w/w), wherein the amount of vegetable fat is from 1-40% (w/w) and wherein the amount of sucrose is from 1-25% (w/w).

The present inventors found that the composition of the invention provides a stable composition, that is suitable for the manufacture of whipped cream and ice cream, that score comparable in texture and sensory attributes as soy based or dairy based products. The rapeseed used to obtain the rapeseed (or canola) protein isolate as applied in the instant invention is usually of the varieties Brassica napus or Brassica juncea. These varieties contain low levels of erucic acid and glucosinolates, and are the source of canola, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Napins are more easily solubilized and are primarily proposed for use in applications where solubility is key. Rapeseed proteins can also be divided into various fractions according to the corresponding sedimentation coefficient in Svedberg units (S). This coefficient indicates the speed of sedimentation of a macromolecule in a centrifugal field. For rapeseed proteins, the main reported fractions are 12S, 7S and 2S. Napin is a 2S albumin, and cruciferin is a 12S globulin. In the context of the present invention, the rapeseed protein comprises cruciferins and napins, preferably from 15 to 65% (w/w) cruciferins and from 35 to 85% (w/w) napins, the total being equal to or less than 100%. In one embodiment the rapeseed protein comprises 40-65% (w/w) cruciferins and 35-60% (w/w) napins, or comprises 80-100% (w/w) cruciferins and 0-20% (w/w) napins, or comprises 0-20% (w/w) cruciferins and 80-100% (w/w) napins, wherein the sum of cruciferins and napins is not exceeding 100% (w/w).

In a preferred embodiment, the present rapeseed protein (isolate) comprises 40 to 65 wt. % cruciferins and 35 to 60 wt. % napins (of the rapeseed protein). Preferably, the present rapeseed protein comprises 40 to 55 wt. % cruciferins and 45 to 60 wt. % napins.

In a preferred embodiment, the present rapeseed protein (isolate) comprises 60 to 80 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) comprises 0 to 10 wt. % cruciferins and 90 to 100 wt. % napins. Preferably, the present rapeseed protein comprises 1 to 5 wt. % cruciferins and 95 to 100 wt. % napins.

Preferably, the amounts of cruciferins and napins calculated based on the total amount of protein in the present cake mix. Or alternatively, the amounts of cruciferins and napins are calculated based on the sum of cruciferins and napins present in the cake mix. Preferably, the amounts of cruciderins and napins are determined by size exclusion chromatography (SEC). Preferably, the amounts of cruciderins and napins are determined by size exclusion chromatography (SEC) using the following test:
samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein comprises 65 to 75 wt. % 12S and 25 to 35 wt. % 2S.

In a preferred embodiment, the present rapeseed protein (isolate) comprises 0 to 10 wt. % 12S and 90 to 100 wt. % 2S. Preferably, the present rapeseed protein comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test: samples of protein isolate are dissolved in a 3.0% (or 500 mM) NaCl saline solution and amounts determined using interference optics.

While 12 S and 2S, or cruciferin and napin, make up the vast majority of the proteins found in rapeseed protein, other proteins can be present in small amounts (less than 5% w/w, 2% w/w/, less than 1% w/w), such as oleosin.

In a preferred embodiment, the composition comprises a ratio of cruciferin to napin in the range of from 1 cruciferin to 0.5 napin to 1 cruciferin to 1.5 napin. Alternatively, the present composition comprises a ratio of cruciferin to napin of at least 9 cruciferin to 1 napin or comprising a ratio of cruciferin to napin of 1 cruciferin to at least 9 napin.

In an embodiment, the composition does not comprise gluten or gliadin, i.e. the composition is so-called gluten-free. By gluten-free is meant that the composition comprises less than 20 ppm of gluten and more preferably less than 10 ppm of gluten. Gluten is usually measured by measuring the gliadin content, for example as described in WO 2017/102535. Therefore, according to the present invention there is provided a gluten-free composition comprising less than 10 ppm gliadin.

In another embodiment the composition does not comprise soy-derived protein. In still another embodiment the composition does not comprise gluten or gliadin and does not comprise soy-derived protein.

Advantageously, rapeseed protein is a natural and versatile protein source useful for many food applications, including ice cream, frozen desserts and whipping creams. In addition, rapeseed protein isolate has a sweetness making it suitable as a substitute for high-calorie sweeteners such as sucrose and the like. Interestingly, products made with rapeseed protein isolate, obtained for example as described in WO 2018/007492, are soluble at pH values ranging from pH 3 to 9.

The present inventors found that rapeseed protein that among others contributes to emulsifying and stabilizing the fat globules in the premix and during its preparation, and facilitates the first incorporation of air before the fat globule network is formed by partial coalescence, by stabilizing the air cell interface.

In an embodiment, the present invention relates to a composition comprising rapeseed protein, a vegetable fat having at least 30% wt. of their fatty-acid moieties as saturated fatty acids, sucrose and water, wherein the amount of rapeseed protein is from 0.1-10% (w/w), wherein the amount of vegetable fat is from 1-40% (w/w) and wherein the amount of sucrose is from 1-25% (w/w).

In an embodiment, the amount of rapeseed protein is from 0.5-6% (w/w) of the composition, preferably from 1-5.5% (w/w) of the composition, preferably from 1.6-5% (w/w) of the composition, preferably from 0.5-4% (w/w) of the composition, preferably from 1-3.5% (w/w) of the composition, preferably from 1.6-3.5% (w/w) of the composition, preferably from 1.6-2.5% (w/w) of the composition.

Optionally, a mixture of rapeseed protein and other proteins can be used, such as other plant based proteins such as proteins from legumes and pulses such as pea protein, fava bean protein, chickpea protein, lupin protein, lentil protein, mung bean protein, peanut; or seed proteins such as cotton seed protein, sunflower seed protein, sesame seed protein, camelina; cereal or pseudo cereal protein, such as oat protein, rice protein, corn protein, sorghum protein, quinoa protein, buckwheat; leaf protein such as alfalfa protein, clover protein, duckweed protein, grass protein; stem or root tuber protein such as potato protein, sweet potato protein, cassava protein, yam protein, taro protein; protein derived from nuts, such as almond, hazelnut, walnut, cashew; coconut protein, or proteins from algal, insect or microbial sources, or animal-derived proteins such as milk protein or egg protein.

In an embodiment, the amount of rapeseed protein+other plant-based protein is from 0.5-6% (w/w) of the composition, preferably from 1-5.5% (w/w) of the composition, preferably from 1.6-5% (w/w) of the composition, preferably from 0.5-4% (w/w) of the composition, preferably from 1-3.5% (w/w) of the composition, preferably from 1.6-3.5% (w/w) of the composition, preferably from 1.6-2.5% (w/w) of the composition.

According to the invention, the present vegetable fat has a solid fat content of 20-90% (w/w) at 5° C., preferably a solid fat content of 50-70% at 5° C. Preferably the solid fat content at 35° C. is less than 20%.

The vegetable fat has preferably at least 30% wt. of their fatty-acid moieties as saturated fatty acids or alternatively the present vegetable fat is a triglyceride. In an embodiment the vegetable fat comprises partially solid fat, that is a triglyceride oil mixture with a substantial amount of saturated fatty acids with chain lengths of four to twenty-four C atoms, varying between 20 and 100% of the total amount of fatty acids, preferably leading to solid, crystalline fat content of 20-90% at 5° C., more preferably 50-70% at 5° C., and a solid fat content of less than 10% at 35° C. In this context, the solid fat content and the amount of crystalline fat are the same, and both indicate the amount of fat in a solid or crystalline form, as is known by the person skilled in the art. The solid fat content can be determined by commonly known methods as TD-NMR (Time-Domain Nuclear Magnetic Resonance) and DSC (differential Scanning Calorimetry). Preferably, the vegetable fat or the fat blend is chosen such to fulfil the criteria for solid fat content mentioned before, and can be chosen from the group consisting of coconut fat, palm fat, or fractions thereof, cacao fat, babassu fat, illipe fat, shea fat, palm kernel fat, corn oil, rapeseed or canola oil, soybean oil, sunflower oil, camelina oil and mixtures thereof, or interestified blends of vegetable oils and fats. Optionally, the vegetable fat consists partially of hardened oils or fat by suitable methods known in the art, such as hardened corn oil, hardened rapeseed oil or canola oil, hardened soya bean oil, hardened sunflower oil, hardened palm oil, hardened palm kernel oil or hardened coconut oil. The vegetable fat can be either used as such without modification, or used after chemical of enzymatic interesterification, or after fractionation optionally followed by interesterification. Commercial fat blends are known in the field such as Akomix or Akotop from AAK, or equivalents of other suppliers. Preferably the vegetable fat is rich in medium chain saturated fatty acids, such as 20-90%, more preferred 40-80%. Medium chain fatty acids are usually fatty acids of 8 to 14 C atoms long. The total amounts of solid fat is preferably between 1-40% (w/w) of the composition. Preferably, the amount of vegetable fat is 5-35% (w/w) of the composition, more preferably 10-30% (w/w) of the composition. The term oil or fat can be used interchangeably.

The present composition comprises sucrose. Preferably, the amount of sucrose is from 1-15% (w/w) of the composition, preferably the amount of sucrose is from 2-10% (w/w) of the composition.

Preferably the composition does not contain lactose.

Further, the present composition may comprise sweeteners obtained by hydrolysis of starch such as corn, tapioca, potato, rice, oat or wheat, dextrose, fructose lactose, maltose, honey, invert sugar, in ranges of 12-20% of sucrose equivalents. It can also contain alternative, low calorie sweeteners such as steviol glycosides, sugar alcohols such as glycerol, sorbitol, mannitol, xylitol and so forth, aspartame, acesulfame K, or sucralose. Such low-calorie sweeteners are usually added in a lower concentration than sugar, that depends on the type of low-calorie sweetener, ranges of 0.01-1% (w/w) of the composition. In addition, the carbohydrate functions as a bulking agent to increase the total solids levels in the product, needed to improve body and texture of the frozen product. This results in desirably soft product that still is scoopable and chewable. It also results in the freezing point depression. The right level of total solids can be obtained be either the sweetener components mentioned above and can be complemented by low-sweetness maltodextrins with lower DE (Dextrose Equivalent, usually lower than 20), hydrolyzed starches, polydextrose, soluble fibers, inulin. With a too high level of bulking agents, frozen products become too soft, too dense, too chewy. Total non-sweetener bulking agent levels may vary from 1-20% (w/w) of the composition.

In an embodiment, the composition further comprises an emulsifier. An emulsifier promotes formation and/or stability of emulsions. In the case of ice cream and whipping creams it is crucial that the emulsifier promotes crystal growth of the triglycerides during the ripening phase, and thereby assist in the crucial step of partial coalescence in the whipping/aeration phase. Suitable emulsifiers may be the ones known to the skilled person, for example phospholipids (e.g. lecithin and the like), fractionated, or hydrolyzed, or calcium, magnesium, potassium, or sodium salts of fatty acids, mono- and diglycerides (MDG), preferably saturated MDG, and derivatives thereof such as lactic acid esters (“Lactem”) of MDG, acylated tartaric acid esters (“Datem”) of MDG, sorbitan esters of monostearate (Tweens and Spans), sugar esters of fatty acids, polyglycerolesters of fatty acids and the like. Typically, combinations of emulsifiers can be used, such as a combination of MDG and lactic acid esters of MDG. Commercial mixes are known in the art, such as CreamWhip 440 from Palsgaard, or mixtures of emulsifiers and hydrocolloids such as Extrulce 252 (Palsgaard), or Cremodan Hi-Whip NP (Danisco). Typically, between 0.1 and 1.5% emulsifier is used. Preferably, the amount of emulsifier is from 0.02-2% (w/w) of the composition, preferably the amount of emulsifier is from 0.1-1.5% (w/w) of the composition such as around 0.5% (w/w) of the composition.

In an embodiment—stabilizers, mostly hydrocolloids, are added among others to increase the viscosity of the premix (among others to prevent creaming during ripening), to assist in producing a stable foam during freezing, to slow down growth of ice crystal or sugar crystals during storage, especially during temperature fluctuations or heat shock (ice cream being taken out of the freezer for a while and then back in), to keep the product in shape during melting and to give smoothness of the product in mouth during consumption. Hydrocolloids are a diverse group of long chain polymers characterized by their property of forming viscous dispersions and/or gels when dispersed in water. In the context of the invention, suitable hydrocolloids are galactomannans (guar gum, locust bean gum (LBG) and tara gum), gellan (including low or high-acyl gellan), xanthan, low- and high-methoxy pectins, alginates, carrageenans, gum Arabic, cellulose derivatives such as carboxymethyl cellulose, hydroxypropylmethyl cellulose, methyl cellulose, native and modified starches, citrus fibers and the like. Preferably a mix of hydrocolloids may be used such as a mixture of locust bean gum and guar gum. Preferably, the amount of hydrocolloid is from 0.02-1% (w/w) of the composition. More preferably, the amount of hydrocolloid is from 0.1-1% (w/w) of the composition.

The present composition may further comprise bulking agents. Preferred bulking agents are polydextrose, maltodextrin, sugar alcohols, corn syrup solids, sugars and starches. Preferably, the bulking agent is present in an amount of 0.5-20% (w/w) of the composition.

In an embodiment, the present composition further comprises maltodextrin, wherein the amount of maltodextrin is 0.5-20% (w/w) of the composition.

The present composition may further comprise flavours. The most common flavour in ice cream is vanilla. In a further embodiment, other flavours can be used including fruit flavours, hazelnut or other nuts, pistachio, chocolate, caramel, liquorice, mint, and/or pieces can be added such as nut or peanut pieces chocolate pieces or chunks, cookie dough pieces, fruit pieces, fudge, nougatine (sugared nut pieces), etcetera. Preferably, a flavour is present in an amount of 0.05-5% (w/w) of the composition, such as present in an amount of 0.05-3% (w/w) of the composition.

Further, the present composition may comprise minerals, such as sodium chloride. Calcium salts, such as for example calcium phosphate, have the advantage that the nutritional value of dairy products can be mimicked. Certain counterions may impact the protein behaviour in the premix, and in the final product. Preferably, the amount of minerals is within the range of 0.05-1% (w/w) of the composition, such as from 0.1-0.5% (w/w) of the composition.

In an embodiment, the composition has a pH between 5.0 and 9.0, or between 6.0 and 8.0, when measured at 20±2° C.

In an embodiment, the composition is an oil-in-water emulsion wherein the size of the emulsion (oil) droplets has a D50 within the range of 2-20 μm and/or a D90 within the range of 5-50 μm, preferably a D50 within the range of 4-15 μm and/or a D90 within the range of 10-30 μm, preferably wherein the size of the emulsion (oil) droplets is measured according to test A. Preferably, the size of the emulsion (oil) droplets has a D50 within the range of 2-20 μm, 3-15 μm, 4-12 μm, 5-10 μm. Preferably, the size of the oil droplets has a D90 within the range of 10-20 μm, 5-15 μm, 10-25 μm, 5-10 μm. Preferably, the size of the oil droplets has a D10 within the range of 1-10 μm, 1.5-5 μm, 1.6-4 μm, 1.7-3 μm.

The droplet size—expressed as the D50, D10 or D90 (corresponding to respectively 50% (median), 10% and 90% particle size for a volume distribution), can be measured by particle size distribution assessment methods such as light scattering, and further checked using light microscopy.

Test A comprises:
measuring the Particle Size Distribution (PSD) of the oil droplets by laser diffraction particle size analysis, using preferably a Beckman-Coulter LS13320 particle size analyzer, combined with the Fraunhofer.rf780d model, with a pump speed set at 40%, the laser obscuration around 20% (780 nm) and the PIDS obscuration around 40% (450 nm);
the 10%, 50% (median) and 90% particle size for a volume distribution are annotated as D10, D50 and D90 (=X10, X50, X90).

Alternatively, the PSD can be determined by for instance a Mastersizer 2000 (Malvern Instruments), according to ISO13320-1. From the PSD results, the specific surface area (SSA) and Sauter mean diameter (D_{3,2}) can be derived and used for comparison of particle size distribution between samples. Any person skilled in the art will be able to analyze the PSD by light scattering instruments such as those used here.

Light microscopy analysis was employed to confirm that the droplet sizes are essentially smaller than indicated values. For this an Olympus CX41 microscope equipped with UC30 digital microscope camera and U-TV1X-2 adapter (Olympus) was used. Samples were prepared undiluted, directly after processing. Magnification was set at 20 times.

In an embodiment, the present composition is unpasteurized. Preferably the present (premix) composition has a temperature within the range of 30 to 50° C. before pasteurization and homogenisation. Preferably, the unpasteurized composition, or the premix emulsion before pasteurization and homogenisation comprises a D50 within the range of 2-20 μm, 3-15 μm, 4-12 μm, 5-10 μm.

In the present invention, preferably rapeseed protein is used where the proteins are to a large extent in their native form. During heat treatment, these proteins can denature. Particularly the cruciferin fraction of the rapeseed protein can denature in part or fully during conditions applied during common pasteurization processes, such as used in the art, like 20 seconds at 72° C. Thus, by analyzing the state of nativity, the difference between a non-heat treated and heat-treated emulsion made with rapeseed protein can be determined. Such state of nativity can be determined by for instance DSC (differential scanning calorimetry) or other methods known in the art.

In an embodiment, the present rapeseed protein has an enthalpy of denaturation in the hydrated state (ΔH value) of around 0, for example of from 0 to 1 J/g or of 0±0.5 J/g. The ΔH value may be established for example by measuring a 40% (w/w) solution or dispersion of rapeseed protein isolate in water by means of Differential Scanning Calorimetry (DSC). This enthalpy of denaturation can be the result of the pasteurization step. Native rapeseed protein isolate usually has an enthalpy of denaturation in the hydrated state of from 1 to 10 J/g, or of from 2 to 6 J/g of a 40% (w/w) protein solution.

Overrun is the amount of air or gas incorporated into the composition by the aeration process, expressed in percentages, and can be calculated by ([density of the composition before aeration]−[density of the aerated composition] divided by [density of the aerated composition])×100%. Overrun is measured at atmospheric pressure. In frozen form, the composition may have an overrun between 25 and 200%, more preferably between 50 and 150%. A low overrun makes the ice cream hard and sometimes more difficult to consume, a high overrun leads to a fluffy product. The ice cream producer can vary this overrun level according to its wishes.

In the form of a whipping cream, the composition (after whipping) may have an overrun between 80 and 300%, more preferably between 150 and 250%.

In an embodiment, the balance (to 100% w/w) of the remaining ingredients may be water, preferably the balance is water. More preferably, the present composition comprises an amount of water up to 100% (w/w) of the composition. Preferably, the present composition comprises an amount of water of 40-90% (w/w) of the composition, more preferably of 50-75% (w/w) of the composition.

In an embodiment, the composition comprises an amount of rapeseed protein from 0.1-10% (w/w), an amount of vegetable fat from 1-20% (w/w), an amount of sucrose from 5-25% (w/w) and an amount of maltodextrin from 3-20%. Such a composition is particularly suitable as premix for the manufacture of an ice cream. A premix refers to the mixture of the ingredients which make up the froze ice cream composition prior to freezing. Preferably, the composition comprises an amount of rapeseed protein from 1.6-6% (w/w), an amount of vegetable fat from 5-15% (w/w), an amount of sucrose from 5-20% (w/w) and an amount of maltodextrin from 5-15%.

In an embodiment, the composition comprises an amount of rapeseed protein from 0.1-10% (w/w), an amount of vegetable fat from 20-40% (w/w), an amount of sucrose from 1-10% (w/w) and an amount of maltodextrin from 0.5-10%. Such a composition is particularly suitable for the manufacture of whipping or whipped cream. The composition can be sold as such or in the form of a whipped cream. Preferably, the composition comprises an amount of rapeseed protein from 1.6-6% (w/w), an amount of vegetable fat from 25-35% (w/w), an amount of sucrose from 1-5% (w/w) and an amount of maltodextrin from 1-7%.

In an embodiment, the composition is in frozen form, a powder form, liquid form, or in the form of a whipping cream or a whipped cream.

For a powdered form, the product can be made according to the here described method, and the premix can after pasteurization and high-pressure homogenization be dried by methods known in the art, such as spray drying. In an alternative method only a part of the premix containing at least the protein and the fat and the emulsifier is made as a fine emulsion, pasteurized, homogenized and spray dried, after which the other components can be added. For instance, a premix containing the protein, the fat, the emulsifier and the maltodextrin can be made according to the invention, sheared to obtain a fine emulsion according to the invention, and then pasteurized, homogenized, and spray dried, after which other components can be added, such as the sugar, the hydrocolloids, the flavour. The dried mix can be rehydrated by the end user, after ripening the mix can be turned into ice cream. Alternatively, the dry mix can be hydrated and used to make soft serve ice cream for direct consumption after freezing.

In an embodiment, the weight ratio between fat or oil and protein is at least 3:1, more preferably at least 5:1 or 6:1. For example, the weight ratio between fat and protein may be 6:1 or the like, such as around 6.2:1. For a whipping cream product this may even be at least 30:1

In a second aspect, the present invention relates to a method for the preparation of a composition comprising rapeseed protein, a vegetable fat having a solid fat content of 20-90% (w/w) at 5° C., sucrose and water, comprising the steps of:
a) preparing an emulsion with the rapeseed protein, the vegetable fat, the sucrose and the water using high shear, resulting in an emulsion an oil-in-water emulsion, wherein the size of the emulsion droplets has a D50 within the range of 2-30 μm and/or a D90 within the range of 10-50 μm;
b) optionally pasteurizing the oil-in-water emulsion;
c) homogenizing the oil-water-emulsion at a pressure from 100 to 500 bar; and
d) cooling down the homogenized oil-in-water emulsion to a temperature between 0° C. and 20° C. for a time period of at least 1 hour.

It was found that instability associated with the pasteurization of ice cream premixes containing rapeseed protein can be overcome by sufficient shear (such as by powerful rotor-stator mixing devices or optionally high-pressure homogenization) to obtain small fat globules of size D50 within the range of 2-30 μm.

Further, the instant invention demonstrates that a protein level between 0.1 and 5% more preferably 0.2 and 3% more preferably between 0.3 and 2% are required to obtain ice cream products with proper textural properties. Further, the instant invention demonstrates that the optimum hydrocolloid level is a balance between premix stability and final textural properties and depends on the type of hydrocolloid mixture.

Preferably, the present method relates to a method for the preparation of a composition as defined in the first aspect of the invention, including all its embodiments and combinations thereof.

In present step a) an emulsion is prepared with the rapeseed protein, the vegetable fat and the sucrose. The skilled person is aware of common techniques for the preparation of an emulsion. For example, present step a) comprises mixing the rapeseed protein, sucrose with water, and stirring the mixture for >10 minutes to fully hydrate the protein to create an aqueous solution, and melting the vegetable fat, followed by dispersing the melted fat into the aqueous solution using high shear mixer.

Shear in production processes of emulsions can be anywhere between very mild and low to highly violent and high—a sliding scale, depending on the need. Mild shear treatment can be for instance manual stirring, stirring using a magnetic stir bar, or an overhead mixer with a propeller mixer attached turning with a rate of 200 rpm (rounds per minute). High-shear mixing can be obtained by equipment that imposes a much higher shear force on the mixture, such as a rotor/stator mixer, either in a batch process, or by an in-line unit operation where the emulsion can be pumped through. High pressure homogenization is another type of high shear mixing operation. Other factors that play a role in proper mixing are the time that the shear is imposed on the mixture, and the volume of the emulsion to be mixed relatively to the shearing device. Other high-shear mixers are known in the art. High-shear mixers, such as rotor/stator mixers, are commonly used in the production of emulsions. The term ‘high shear’ is herein defined as shear sufficient to result in an oil-in-water emulsion, wherein the size of the emulsion droplets has a D50 within the range of 2-30 μm and/or a D90 within the range of 10-50 μm. Alternatively, phrased, present step a) comprises preparing an emulsion with the rapeseed protein, the vegetable fat, the sucrose and the water using high shear, resulting in an emulsion an oil-in-water emulsion, wherein the size of the emulsion droplets has a D50 within the range of 2-30 μm and/or a D90 within the range of 10-50 μm.

Preferably, present step a) results in an oil-in-water emulsion, wherein the size of the emulsion droplets has a D50 within the range of 2-30 μm and/or a D90 within the range of 5-50 μm, preferably a D50 within the range of 4-15 μm and/or a D90 within the range of 10-30 μm. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm. Preferably, the size of the emulsion droplets has a D10 within the range of 1-10 μm, 1.5-5 μm, 1.6-4 μm, 1.7-3 μm. Preferably, emulsion droplets size D50 within the range of 2-20 μm, 3-15 μm, 4-12 μm, 5-10 μm.

In present step b) the oil-in-water emulsion is preferably pasteurized by exposing the oil-in-water emulsion to a temperature within the range of 65 and 100° C. or 70-80° C. for at least 15 seconds, such as at least 20 seconds. Preferably for not longer than 60 seconds, 5 minutes or 10 minutes.

In present step c) the (optionally pasteurized) oil-in-water emulsion is homogenized, preferably using a pressure from 150 to 350 bar, more preferably from 180 to 325 bar, most preferably from 200 to 250 bar. Pasteurization is advantageous for increasing shelf life, and also to prevent microbial outgrowth during the ripening phase of step c).

Present step c) relates to cooing down the homogenized oil-in-water emulsion to a temperature between 0° C. and 20° C. for a time period of at least 1 hour, preferably for a period that is sufficient for ripening of the composition, preferably sufficient to allow the fat phase to recrystallize. Preferably, the time period is from 1 to 100 hours, such as from 2 to 48 hours, such as from 10 to 30 hours. Preferably the temperature is within the range of 2° C. and 20° C., such as within the range of 4° C. and 20° C., or 5° C. and 15° C.

In an embodiment, present step a) comprises the use of a hydrocolloid and/or emulsifier. The hydrocolloid and/or emulsifier may be as defined above for the first aspect of the invention.

Further, present step a) may comprise the use of maltodextrin. Preferably, present step a) comprises preparing an emulsion with the rapeseed protein, the vegetable fat, the sucrose, maltodextrin and the water using high shear, resulting in an emulsion an oil-in-water emulsion, wherein the size of the emulsion droplets has a D50 within the range of 2-30 μm and/or a D90 within the range of 10-50 μm.

In an embodiment, an emulsifier is added during step a). In another embodiment the emulsifier may be added in step b). An emulsifier may facilitate oil droplet break up during emulsification, may assist to stabilize the emulsion and may promote crystal growth of triglyceride crystals. Suitable emulsifiers are defined above.

In an embodiment, the present method comprises the steps of:
a) preparing an aqueous solution comprising rapeseed protein, and sucrose,
b) preparing a fat phase, by melting the vegetable fat and adding an emulsifier
c) adding the fat phase to the water phase while stirring
d) dispersing the fat phase in the water phase using a high-shear device to obtain oil droplets with a D50 less than 50 μm, more preferably of 2-30 μm
e) pasteurizing the premix at a temperature of 70-80° C. for at least 15 seconds
f) directly followed by a high-pressure homogenization step, and
g) cooling down the premix and allow to ripen at a temperature between 0-20° C. for at least 16 hours.

In an embodiment, the present method further comprises the steps of freezing and aerating the composition resulting from step d) for the provision of an ice cream. Hence, the present method may relate to a method for the preparation of an ice cream.

In an alternative embodiment, the present method further comprises the step of whipping the composition resulting from step d) for the provision of a whipped cream. Hence, the present method may relate to a method for the preparation of a whipped cream.

In the case of a whipping cream, the product can be subjected to sterilization, such as a UHT treatment, followed by hygienic filling, to obtain a long-shelf-life stable product, such as is known in the art.

According to another aspect, the present invention relates to the use of the present composition for the manufacture of an ice cream or a whipping (whipped) cream.

According to another aspect, the present invention relates to a food product comprising the present composition according to any of the preceding claims, wherein the food product is an ice cream or a whipped cream. The present ice cream or whipping cream is packaged in a container which may be a can beaker carton or the like, made from paper, glass, aluminum, a plastic and the like. Ideally the package has a volume that can hold beverage volumes that are normally supplied to consumers, i.e. from 0.2 to 2.5 L, for example 0.25 L, 0.3 L, 0.33 L, 0.5 L, 0.7 L, 0.75 L, 1 L or 1.5 L-3 L.

The present invention is further illustrated in the examples below.

### EXAMPLES

### Materials

Rapeseed protein isolate (RPI) was prepared from cold-pressed rapeseed oil seed meal as described in WO 2018/007492; the protein content was 90% (w/w), batch number PB18504. The resultant rapeseed protein isolate comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 23±2° C.

Other ingredients used: Locust bean gum (LBG, Tate & Lyle Cesagum LN). Ice cream emulsifier & stabilizer mix: either Extrulce 252 (Palsgaard), or Cremodan Hi-Whip NP (Danisco, containing lactic acid ester of MDG, MDG, xanthan gum, guar gum, LBG, anti-oxidant: tocopherol, citric acid, ascorbic acid, Ca silicate). Soy protein isolate, Supro Ex33 (Solae) or Profam 921 (ADM), sucrose was locally sourced, glucose syrup (C* 01415 from Cargill or from Royal Steensma/locally sourced), maltodextrin DE9 (tapioca, Ingredion, or wheat, Roquette, or C*Dry MD 01904 from Cargill). Palm kernel oil was from AAK. Unless stated otherwise, all other chemicals were from Merck.

The high-shear mixer was from Silverson, Monowave from Anton Paar (Oosterhout, the Netherlands), Thermomixer from Vorwerk (Switzerland), Homogenizer (M110D) from Microfluidics, Particle sizer (LS13320) from Beckmann Coulter.

### Test Methods

Measurement of pH: the pH was measured using a Radiometer (PHM220) combined with a Hamilton Slimtrode electrode (SN21564).

PSD light scattering: Laser diffraction particle size analyses of the samples produced at 3-L scale were performed with the Beckman-Coulter LS13320 particle size analyzer, combined with the Fraunhofer.rf780d model. The pump speed was set at 40%. The laser obscuration was around 20% (780 nm) and the PIDS obscuration around 40% (450 nm). The 10%, 50% (median) and 90% particle size for a volume distribution were annotated as D10, D50 and D90 (=X10, X50, X90). Laser diffraction analyses of the samples that were produced at 40-L scale were performed with the Mastersizer 2000 (Malvern Instruments), according to ISO13320-1. The specific surface area (SSA) and Sauter mean diameter (D_{3,2}) were used for comparison of particle size distribution between samples.

Light microscopy analysis was performed with the Olympus CX41 microscope equipped with UC30 digital microscope camera and U-TV1X-2 adapter (Olympus). Samples were prepared undiluted, directly after processing. Magnification was set at 20 times.

Overrun: The foam capacity was based on the volume of air that was incorporated after whipping. This was analyzed with a standardized measuring cup (cup nr. 1956, cup volume 220.0 ml, cup diameter 8 cm, cup weight 104.2 g; Rosle). The cup was fully filled with aerated sample and weighed to determine the overrun (%) and density (g/L) of the foam, based on the corresponding weight tables.

Particle size distribution of air cells, and ice crystals in the ice cream by Scanning Electron Microscopy SEM: Random samples (volume elements of edge length of 1.5 mm) were taken from ice cream, frozen in super-cooled liquid nitrogen and inserted in into the cryo preparation system. There the samples were broken, and surface etched by sublimation. Finally, the surface was sputtered with gold in deep frozen state. The prepared samples were transferred into the SEM at approximately −180° C. The particle size distribution of air cells and ice crystals in the ice cream samples were determined by image analysis: Contours of the particular dispersed phase were marked. The area A of structure elements were determined by calculating of pixel areas within the contours.

Melting behavior: the melting behavior of the ice cream was analyzed based on the mass loss caused by dripping at 25° C., at 70% RH in a conditioning cabinet depending on time. In advance of the measurement, the ice cream cylinders were equilibrated at −20° C. and sited on a sieve.

Extractable fat content (EFC): accessibility of dispersed lipid phase was determined by measuring EFC according to the method described by Kielmeyer & Schuster. The total quantity of fat was determined by non-polar solvent extraction of the emulsion.

Compression strength: determination of stress (σ) necessary to penetrate a cone (angel 10°) at −18° C. into the sample for 30 mm (compression speed 1 mm/s).

### Example 1

### Ice Cream Trial without Proper Premix Dispersion

Three batches of each 40 L premix as indicated in the table 1 below were prepared as follows: an aqueous solution comprising skim milk powder (SMP) or soy protein isolate (SPI) or rapeseed protein isolate (RPI), carbohydrates, hydrocolloids and emulsifier was made. Total dry matter content was kept constant. Differences of dry matter content was equalized by maltodextrin (DE 9). The fat phase was prepared by melting the fat. The fat phase was added to the water phase while thoroughly stirring. No specific precautions were taken to obtain a finer dispersion (like high shear as in example 2).

Subsequently, the premix was pasteurized at a temperature of 84° C. for 40 seconds, directly followed by a high-pressure homogenization step at a pressure of 180/50 bar. The premix was cooled down 6° C. and allowed to ripen for at least 20 hours.

Freezing/aerating the mix in a WCB MF 75 ice cream device with mass flow of around 30 kg/hr, detailed settings are given in the table 2 below. The temperature of premix at inlet was around 6° C., overrun was adjusted to 90-95%. The frozen ice cream variants were filled in 100 mL as well as 1 L containers and subjected to the hardening process. Hardening of the ice cream at −40° C. for at least 16 hours, and after that the product was stored at −18-20° C. for at least one week before further characterization was done.

TABLE 1
Recipes

| | SMP-based | SPI-based | RPI-based |
|---|---|---|---|
| Ingredients | g/100 g | g/100 g | g/100 g |
| Palm kernel fat | 10.5 | 10.5 | 10.5 |
| Skim milk powder | 10.6 | — | — |
| Soy protein isolate | — | 3.4 | — |
| Rapeseed protein isolate | — | — | 3.4 |
| Sucrose | 12 | 12 | 12 |
| Glucose syrup C* 01415 | 5 | 5 | 5 |
| Maltodextrin C*Dry MD 01904 | — | 7.2 | 7.2 |
| Emulsifier/stabilizer mix | 0.5 | 0.5 | 0.5 |
| Guar gum/locust bean gum (1:1) | — | — | — |
| Water | 61.4 | 61.4 | 61.4 |
| Total | 100 | 100 | 100 |

TABLE 2
Process parameters

| | | |
|---|---|---|
| Process step | Temperature | time |

| | | | | |
|---|---|---|---|---|
| Pasteurization | 84° | C. | 40 | s |
| Cooling | 7-8° | C. | 60 | s |
| Aging | 5° | C. | 20-24 | h |
| Freezing | | | | |
| Input | 5° | C. | ~90 | s |
| Output | −5.5° | C. | | |
| Hardening | −40° | C. | 14-16 | h |
| Storage | −18° | C. | 7 | days |

TABLE 3
The droplet size distribution after
pasteurization and homogenization

| | D50 | D10 | D90 | SSA | | D_{3, 2} |
|---|---|---|---|---|---|---|
| Sample Mix | (μm) | (μm) | (μm) | (m²/g) | Span | (μm) |
| SMP | 0.91 | 0.28 | 2.22 | 10.2 | 2.13 | 0.64 |
| Soy | 1.42 | 0.55 | 49.8 | 5.24 | 34.73 | 1.25 |
| Rapeseed | 22.99 | 4.08 | 77.11 | 0.84 | 3.18 | 7.73 |

From the figures for PSD given in the table it shows that the RPI-based premix emulsion had much larger droplet sizes than the other two. Even though this PSD is after pasteurization and homogenization, the PSD before will be even higher. The difference in PSD was also observed from the extractable fat content of the mixes: for SMP and SPI this was low (4, or 2 g/100 g fat respectively) compared to 21 g/100 g fat for the RPI premix.

The densities of these premixes were about equal around 1.1 kg/L

While the ice creams were produced under identical conditions, the overrun of the products differed substantially: SMP 142%; SPI 148% and RPI 99%. Similar patterns were observed for gas cell size distributions, that were about equal for the SMP and the SPI product, but the RPI product showed much larger gas cells. The size of fat agglomerates can be illustrated by the parameter specific surface area (SSA). This value represents the ratio of total surface area and total mass of particles. The higher SSA, the lower is the particle size. Thus, it is seen that fat agglomerates in the ice cream products made with SMP and SPI (SSA of 2.4 and 2.1 m²/g respectively) were much smaller than that of the RPI-based ice cream (1.3 m²/g). Values of extractable fat content (EFC) also varied accordingly: SMP 35 g/100 g, SPI 27 g/100 g and RPI 53 g/100 g.

Another parameter that varied is the melting behaviour represented by the dripping degree, a measure of how fast the ice cream melts and collapses. The RPI-based product started under the test conditions to drip after about 7 minutes and was fully melted after about 20 minutes, which is considered very fast, whereas the other two products only started to drip after around 14 minutes and were melted after 24 minutes. Furthermore, the hardness of the ice creams also showed deviating behaviour of the RPI-based product, which in part can be explained by its lower density: hardness of SMP-based was around 100 g, of SPI-based around 220 g, and RPI-based around 720 g.

For ice cream the emulsion stability and its response to shear and freezing is a delicate balance between remaining stable/facilitating just enough fat crystal growth and instability upon whipping/aeration. All the facts presented here point to a poor emulsion and poor aeration of the RPI-based ice cream product under these processing conditions and with this particular composition.

### Example 2

### Ice Cream Premix Compositions and Stability Against Heating and Aeration Optimization

In this example the effect of sufficient shear to the premix before pasteurization is shown. The ice cream premix compositions that were studied are given in table 4. First, Protein, sucrose, maltodextrin, and emulsifier stabilizer mix were mixed in water were mixed in water, and the mixture was stirred for >30 minutes to fully hydrate the protein powders. The solid palm kernel fat was melted in a separate container in a water bath at 40° C. The melted palm kernel fat phase was mixed into the aqueous phase using a high-speed mixer equipped with ‘emulsor’ screen (L4RT Silverson). After mixing the emulsions were pasteurized with using an Armfield FT74X UHT/HTST processing system, hereafter called ‘Armfield’. To obtain a heating profile of 75° C., 20 s, the following settings were used: pump speed 72% (with according 20 s sample hold time), inlet pressure around 4 bar, hot water temperature 95° C., outlet temperature cooling water 5° C. (with according 20° C. sample outlet temperature). A total volume of 3 L per sample was pasteurized, with a death volume of 1 L.

After heat treatment, the premixes were homogenized by a Panda NS1001 L2K (GEO NIRO) high-pressure homogenizer, equipped with the emulsion type valve (ball; PS). The first and second stage were set at 20 and 210 bar respectively, resulting in a total pressure of 230 bar. A total volume of 2 L per sample was homogenized, with a death volume of 0.5 L. Afterwards, samples were filled in bottles (Schott) that were stored at 4° C. overnight.

The aged samples were whipped (250 g) for 8 min at maximum speed, using the Hobart mixer equipped with the wire whip. The aerated mixture was poured into a glass measuring cylinder (500 mL) that was stored at room temperature (˜5 h). The total volume of the whipped product was measured over time.

TABLE 4
Overview of studied compositions (g/100
g) of rapeseed and soy ice cream

| | | 1.7% RPI + | |
|---|---|---|---|
| Ingredients | 1.7% RPI | 0.1% LBG/GG | 5.1% RPI |
| Palm kernel fat | 10.5 | 10.5 | 10.5 |
| Soy protein isolate | — | — | — |
| (Profam 921; ADM) | | | |
| Rapeseed protein isolate | 1.7 | 1.7 | 5. |
| Sucrose | 12.0 | 12.0 | 12.0 |
| Glucose syrup | 5.0 | 5.0 | 5.0 |
| Maltodextrin | 8.9 | 8.8 | 5.5 |
| Emulsifier/stabilizer mix | 0.5 | 0.5 | 0.5 |
| (Palsgaard Extrulce 252) | | | |
| Locust bean gum (LBG)/ | — | 0.1 | — |
| guar gum (GG) (1:1) | | | |
| Water | 61.4 | 61.4 | 61.4 |
| Total | 100 | 100 | 100 |

Table 5 provides an overview of the change in PSD during processing per premix. Homogenization with the Panda homogenizer effectively decreased the oil droplet size in all ice cream premixes as was observed by light microscopy (images not shown). This was not observed by particle size distribution measured by light scattering

The light microscopy images of the ice cream premixes after overnight aging showed that the average individual droplet size and degree of flocculation were visually comparable before and after aging treatment. Generally, no substantial effect of the RPI level on the ice cream processing was observed based on the PSD and light microscopy images after aging. The 5.1% RPI-containing premix showed a slightly smaller distribution in particle size with specifically lower d90 size, compared to the other compositions.

In contrast to the PSD and light microscopy results, clear differences between the compositions were observed based on the phase separation after aging, and overrun and foam stability after whipping (Table 6). The 1.7% and 3.4% RPI samples showed a serum phase at the bottom of the bottle after aging. The 3.4% RPI mixtures without pasteurization or with pasteurization did not show phase separation, indicating a more stable emulsion.

A relatively higher overrun was observed for premixes with lower RPI content, i.e. <12%, 22% and 24% overrun for ice cream mixtures with 5.1%, 3.4% and 1.7% RPI, respectively. The 1.7% mixture and the 3.4% mixture without pasteurization showed relatively weak foam stability, i.e. a darker serum phase at the bottom of the cylinder appeared after 3 hours of storage at room temperature which was comparable to the phase separation after aging. Based on these findings, it was concluded that the RPI content and pasteurization treatment all showed an effect on the overrun (foam capacity) and foam stability of the samples.

As pasteurization is often required in ice cream production, most promising results regarding overrun were obtained by lowering the RPI content. To reduce phase separation during aging and increase foam stability, 0.1% hydrocolloids (1:1 locust bean gum:guar gum, w/w) were added to the 1.7% RPI premix. After homogenization and aging, the PSD of the premix with 1.7% RPI+0.1% LGB/GG was comparable to the mixtures without additional hydrocolloids (Table 4). Based on light microscopy analysis, the premix with 1.7% RPI+0.1% LGB/GG showed relatively less droplet clustering and aggregation.

The addition of 0.1% LBG/GG was sufficient for the 1.7% RPI mixture to avoid phase separation after aging (visual observation). Moreover, an overrun of 29% was obtained with good foam stability after 3 hours of storage. It was therefore concluded that the premix with 1.7% RPI+0.1% LGB/GG may be a good starting point to obtain good ice cream quality.

TABLE 5
PSD of rapeseed protein ice cream premix during processing

| | D10 (μm); | D50 (μm); | D90 (μm); |
|---|---|---|---|
| | CV (%) | CV (%) | CV (%) |
| | 1.7% rapeseed premix | | |
| Before heat treatment | 1.8; 4.4% | 4.8; 13.5% | 9.4; 29.7% |
| After Armfield | 1.8; 6.1% | 4.3; 4.1% | 7.6; 9.9% |
| (75° C., 20 s) | | | |
| After Armfield | 2.1; 7.8% | 9.9; 10.6% | 20.9; 6.6% |
| (75° C., 20 s) + | | | |
| Panda | | | |
| After Armfield | 1.7; 1.4% | 6.6; 1.3% | 19.4; 6.6% |
| (75° C., 20 s) + | | | |
| Panda + aging | | | |
| | 1.7% rapeseed + 0.1% LBG/GG premix | | |
| Before heat treatment | 2.1; 5.0% | 7.3; 0.9% | 18.2; 4.8% |
| After Armfield | 2.8; 2.1% | 18.6; 2.5% | 53.2; 4.7% |
| (75° C., 20 s) | | | |
| After Armfield | 1.8; 4.7% | 7.6; 6.2% | 16.2; 5.0% |
| (75° C., 20 s) + | | | |
| Panda | | | |
| After Armfield | 1.7; 1.7% | 6.0; 1.1% | 15.4; 1.2% |
| (75° C., 20 s) + | | | |
| Panda + aging | | | |
| | 3.4% rapeseed premix | | |
| Before heat treatment | 1.6; 7.8% | 4.4; 3.4% | 9.1; 4.1% |
| After Armfield | 1.7; 0.9% | 5.9; 0.8% | 13.3; 0.4% |
| (75° C., 20 s) | | | |
| After Armfield | 2.7; 3.8% | 12.1; 3.1% | 25.0; 2.2% |
| (75° C., 20 s) + | | | |
| Panda | | | |
| After Armfield | 2.6; 4.4% | 11.9; 4.9% | 29.4; 6.6% |
| (75° C., 20 s) + | | | |
| Panda + aging | | | |
| | 3.4% rapeseed premix without pasteurization | | |
| Before heat treatment | 1.6; 7.8% | 4.4; 3.4% | 9.1; 4.1% |
| After Panda | 2.8; 7.4% | 10.3; 6.9% | 25.3; 3.0% |
| After Panda + aging | 2.2; 1.4% | 7.9; 1.6% | 28.7; 5.2% |
| | 5.1% rapeseed premix | | |
| Before heat treatment | n.a. | n.a. | n.a. |
| After Armfield | 1.7; 1.5% | 4.3; 2.5% | 9.6; 8.4% |
| (75° C., 20 s) | | | |
| After Armfield | 1.5; 1.7% | 4.7; 2.1% | 10.8; 6.9% |
| (75° C., 20 s) + | | | |
| Panda | | | |
| After Armfield | 1.5; 1.6% | 4.5; 2.4% | 10.0; 8.6% |
| (75° C., 20 s) + | | | |
| Panda + aging | | | |

TABLE 6
Overrun of whipped premixes after ripening

| | | 1.7% RPI + | | 3.4% RPI | |
|---|---|---|---|---|---|
| | | 0.1% | | without | |
| Sample | 1.7% RPI | LBG/GG | 3.4% RPI | Pasteur. | 5.1% RPI |
| Density | 1098 | 1093 | 1099 | 1094 | 1090 |
| before | | | | | |
| whipping | | | | | |
| (g/L) | | | | | |
| Density | 808 | 776 | 822 | 799 | >890 |
| after | | | | | |
| whipping | | | | | |
| (g/L) | | | | | |
| Overrun | 24 | 29 | 22 | 25 | <12 |
| (%) | | | | | |

### Example 3

### Preparation of Ice Cream

In this example it will be shown that proper ice creams can be made by the indicated processing steps, in particular the proper shear imposed on the premix, and that reducing the protein content and increasing the hydrocolloid content has beneficial effects to the final product.

Four batches of each 40 L premix as indicated in the table 7 below were prepared as follows: an aqueous solution comprising RPI or soy protein isolate, carbohydrates, hydrocolloids and emulsifier was made. Total dry matter content was kept constant. Differences of dry matter content was equalized by maltodextrin (DE 9). The fat phase was prepared by melting the fat. The fat phase was added to the water phase while stirring, followed by thorough dispersion using a Silverson high shear rotor-stator device to obtain oil droplets with a D50 of below 20 μm.

Subsequently, the premix was pasteurized at a temperature of 72° C. for 20 seconds, directly followed by a high-pressure homogenization step at a pressure of 180/50 bar. The premix was cooled down 6° C. and allowed to ripen for at least 16 hours.

Freezing/aerating the mix in a WCB MF 75 ice cream device with mass flow of around 30 kg/hr, detailed settings are given in the table XX below. The temperature of premix at inlet was around 6° C., overrun was adjusted to 90-95%. The frozen ice cream variants were filled in 100 mL as well as 1 L containers and subjected to the hardening process. Hardening of the ice cream at −40° C. for at least 16 hours, and after that the product was stored at −18-20° C. for at least one week before further characterization was done.

TABLE 7
Recipes

| | | | | RPI 1.7% + |
|---|---|---|---|---|
| | Benchmark | | | extra |
| | soy protein | RPI 3.4% | RPI 1.7% | stabilizers |
| Ingredients | g/100 g | g/100 g | g/100 g | g/100 g |
| Palm kernel fat | 10.5 | 10.5 | 10.5 | 10.5 |
| Soy protein | 3.4 | — | — | — |
| isolate | | | | |
| RPI (PB18221-5) | — | 3.4 | 1.7 | 1.7 |
| Sucrose | 12 | 12 | 12 | 12 |
| Glucose syrup | 5 | 5 | 5 | 5 |
| Maltodextrin | 7.2 | 7.2 | 8.9 | 8.9 |
| Emulsifier/ | 0.5 | 0.5 | 0.5 | 0.5 |
| stabilizer mix | | | | |
| Guar gum/locust | — | — | — | 0.1 |
| bean gum (1:1) | | | | |
| Water | 61.4 | 61.4 | 61.4 | 61.3 |
| Total | 100 | 100 | 100 | 100 |

TABLE 8
Process parameters

| | | | | RPI 1.7% + |
|---|---|---|---|---|
| | Benchmark | | | extra |
| | soy protein | RPI 3.4% | RPI 1.7% | stabilizers |
| Ripening time | 24 | 24 | 24 | 24 |
| (h) | | | | |
| Pump throughput | 33 | 33 | 33 | 33 |
| (L/h) | | | | |
| Speed cutter spindle | 64 (400) | 64 (400) | 64 (400) | 64 (400) |
| (min⁻¹) | | | | |
| Cooling (%) | 28 | 28 | 28 | 28 |
| Air (%) | 25 | 25 | 25 | 25 |
| Output temperature | −5.0 | −5.2 | −5.4 | −5.0 |
| (° C.) | | | | |
| Overrun (%) | 91.6/89.9 | 93.9/92.2 | 94.8/95.9 | 94.8/97.3 |
| System pressure | 1.66/1.73 | 1.88 | 2.09/2.11 | 1.91/1.95 |
| (bar) | | | | |

*/** begin of filling/end of filling

TABLE 9
Characterization of the premix: particle size distribution
after pasteurization and homogenization.

| | D50 | D10 | D90 | SSA | | D3, 2 |
|---|---|---|---|---|---|---|
| Sample Mix | (μm) | (μm) | (μm) | (m²/g) | Span | (μm) |
| 3.4% SPI | 1.54 | 0.50 | 45.26 | 5.42 | 29.1 | 1.20 |
| 3.4% RPI | 10.48 | 1.82 | 33.77 | 1.38 | 3.05 | 4.73 |
| 1.7% RPI | 7.05 | 1.62 | 17.76 | 1.66 | 2.29 | 3.94 |
| 1.7% RPI + | 4.77 | 1.58 | 11.16 | 1.95 | 2.01 | 3.35 |
| extra stab. | | | | | | |

From table 9 it can be seen that by reducing the RPI content and increasing the hydrocolloid content, the droplet size can be reduced, bringing it closer to the reference, and much smaller than was obtained in the experiment described in example 1 without the given precautions of process and composition. And also the droplet size distribution was smaller than in the earlier example, evidenced by the lower D90 in this case.

After hardening, the four ice cream products had an identical overrun of 100-101%, corresponding to densities of between 0.52 sand 0.54 g/cm⁻³. From particle size measurements obtained by image analysis of electron micrographs of the products it was shown that differences in ice cream structure were seen such as higher number/volume of smaller ice crystals for 1.7% RPI+HC, compared to the other three. The smallest air cells were found for SPI. The product with 3.4% RPI had relatively larger air cells. The SSA (specific surface area) of fat agglomerates was between 2.8 and 4 m²/g, the Sauter mean diameter was between 1.7 and 2.3 (d3.2 μm), which is normal. SPI had the highest SSA/lowest Sauter mean diameter, and the 1.7% RPI+extra hydrocolloids the lowest SSA/highest Sauter mean, meaning larger agglomerated fat particle size.

The extractable fat content (EFC) showed that 1.7% RPI without or with HC had with 15 g/100 g fat the highest value, but still within acceptable range. The value for SPI was around 4 g/100 g. EFC-values change according to coverage of interfaces with proteins and fat crystallization during freezing, hardening and storage of ice cream. Lower content of RPI favoured formation of fat crystal bridges, thus stabilizing air cells.

The dripping degree expressing the melting behaviour was similar for SPI and 1.7% RPI. Extra stabilizers slowed down the melting slightly.

Compression strength, which is an indication for scoopability: the SPI product was slightly but significantly softer than the RPI products, that had near-significantly increase in the order of 1.7+extra HC−1.7%-3.4%.

### Sensory Evaluation of the Ice Cream Products

The sensory profile (harmonised glossary for ice cream evaluation) was performed by Quantitative Descriptive Analysis (QDA). The following sensory attributes of appearance, taste and texture were used:
crumbliness
hardness
coldness
melting rate
smoothness
mouthcoating
viscosity
toughness
sweetness
aftertaste
others

Unstructured lines were used for evaluation of all attributes. Lines were 100 mm long and had two anchor points. The verbal anchors defined and limited each attribute. The panellists were asked to place a vertical mark across the line at that point, which best reflected the note of their perceived attribute intensity. Ten panellists familiar with sensory analyses contributed to preliminary panel sessions. After a training session the results of the panellists were approximately equal. Before the sensory evaluation was started, samples were stored at −15° C. During the sensory evaluation, the samples were analysed by the panel on the basis of the above-mentioned sensory attributes. The results are shown in table 10 below, when the differences were statistically significantly different (P<0.01=***), the groups are indicated by the letters.

TABLE 10

| | | | | | 1.7% RPI + | | | | |
|---|---|---|---|---|---|---|---|---|---|
| | SPI | | 1.7% RPI | | extra stab. | | 3.4% RPI | | p-Value |
| crumbliness | 2.5 | | 2.9 | | 2.8 | | 2.8 | | 0.78 |
| hardness | 6.5 | b | 8.4 | a | 8.7 | a | 8.3 | a | ** |
| coldness | 5.7 | | 6.2 | | 6.5 | | 6.2 | | 0.35 |
| melting rate | 7.1 | a | 6.1 | b | 6.1 | ab | 4.7 | c | *** |
| smoothness | 6.5 | b | 7.6 | a | 5.8 | b | 8.1 | a | *** |
| mouthcoating | 5.2 | b | 6.7 | a | 7.1 | a | 7.3 | a | *** |
| viscosity | 5.0 | b | 5.7 | b | 3.9 | c | 6.9 | a | *** |
| toughness | 1.3 | b | 2.5 | a | 2.0 | a | 2.0 | a | * |
| sweetness | 4.8 | | 4.4 | | 4.1 | | 3.8 | | 0.23 |
| aftertaste | 6.7 | b | 7.6 | ab | 8.4 | a | 7.4 | b | * |
| others | 6.7 | b | 7.5 | b | 8.9 | a | 6.9 | b | ** |

From table 10 it can be seen that differences occur between the products, but the 1.7% RPI+stabilizers comes in many cases close to the SPI reference. In addition, sensory comparisons were made with commercial premium dairy-based ice cream (Haägen Dazs), statistically-based figures could not be given. Yet it showed that compared to these commercial products the group of these four experimental products differed hardly on hardness (except the SPI), coldness, melting rate (except 3.4% RPI), somewhat on smoothness, mouth coating, viscosity and highly on toughness and sweetness (both less than the commercial product, probably because less sugar and bulking), and on aftertaste.

Conclusion: Overall it shows that the products were all good products with proper textural and sensory properties and thus rapeseed protein can be used to replace soy protein.

### Example 4

### Preparation of Whipping Cream

A whipping cream according to the invention may be made using the ingredients listed in the following table. The processing is as follows:
a) Preparing an aqueous solution comprising rapeseed protein, carbohydrates, hydrocolloids, salt
b) Preparing the fat phase, by melting the fat and dissolving the emulsifier in it
c) Adding the fat phase to the water phase while stirring
d) Dispersing the fat phase in the water phase using a high-shear device to obtain oil droplets with a D50 of less than 20 μm
e) Pasteurization of the premix at a temperature of at least 70-80° C. for at least 15 seconds, directly followed by a high-pressure homogenization step.
f) Cooling down the premix and allow to ripen at a temperature between 2-15° C. for at least 16 hours
g) Whipping the product until a firm whipped product is obtained

The emulsifier may also be dispersed in the water phase. A stabilizer mix (mixture of emulsifier and hydrocolloid) may also be added through the oil or the water phase. The stability of the whipped product is checked: firmness of the whipped product, serum leakage and stability of the aerated product over time showed good results.

TABLE 11

| Ingredients | level g/100 g |
|---|---|
| Palm kernel fat | 30 |
| RPI | 1 |
| Sucrose | 2 |
| Maltodextrin | 5 |
| Emulsifier | 0.3 |
| Guar gum/locust bean | 0.2 |
| gum (1:1) | |
| Salt | 0.1 |
| Water | 61.4 |
| Total | 100 |

### Example 5

### Preparation of a Whipping Cream

A whipping cream according to the invention was made using the ingredients listed in table 12.

TABLE 12

| Ingredients | g/100 g | g/4.5 kg |
|---|---|---|
| Coconut fat | 25 | 1125 |
| Sunflower oil | 5 | 225 |
| RPI (GB20134-3) | 1 | 45 |
| Sucrose (Gilse, supermarket) | 3 | 135 |
| Maltodextrin (Diluent White) | 5 | 225 |
| Emulsifier/stabilizer mix | 0.5 | 23 |
| (Palsgaard) | | |
| Locust bean gum (Sigma Aldrich) | 0.2 | 9 |
| NaCl | 0.1 | 5 |
| Water | 60.2 | 2709 |
| Total | 100 | 4500 |

The processing was as follows:
a) An aqueous solution was prepared comprising rapeseed protein isolate (RPI), carbohydrates, hydrocolloids, salt and emulsifier
b) Separately, the fat phase was melted and was added to the water phase while stirring
c) The fat phase was finely dispersed in the water phase using a high-shear device (Silverson) to obtain oil droplets with a D50 of 19.6 μm
d) The premix was pasteurized at a temperature of 70° C. for 30 seconds, directly followed by a high-pressure homogenization step at a total of 300 Bar (stage 1 and 2 combined), using an OMVE HT-122 HTST/UHT system coupled with a GEA TwinPANDA 600 homogenizer. This resulted in a D50 as indicated in the table below.
e) The premix was cooled down and filled in sterile flasks, and allowed to ripen at a temperature between 2-10° C. for at least 16 hours
f) The ripened product was whipped using a Hobart N50 mixer with a wire whisk, for 7 minutes at maximum speed (speed 3).

The whipped product showed an overrun of 125%, no serum leakage from the aerated product was observed in 1 hour, and the aerated product was stable for more than one hour.

| | Median particle size | | |
|---|---|---|---|
| | D50 [μm] | C.V. | st.dev |
| Heated | 13.3 | 1.50% | 0.20 |
| Ripened | 11.7 | 0.10% | 0.012 |

It is expected that with a more thorough dispersion process, as is common in the industry, smaller droplets will be produced that lead to even better stability of the emulsion and better whipping, and higher overruns may be obtained

1. A composition suitable for the manufacture of ice cream and whipped cream comprising rapeseed protein, a vegetable fat having a solid fat content of 20-90% (w/w) at 5° C., sucrose and water, wherein the amount of rapeseed protein is from 0.1-10% (w/w), wherein the amount of vegetable fat is from 1-40% (w/w) and wherein the amount of sucrose is from 1-25% (w/w).

2. The composition according to claim 1, wherein the composition is an oil-in-water emulsion, wherein the size of the emulsion droplets has a D50 within the range of 2-20 μm and/or a D90 within the range of 5-50 μm, optionally having a D50 within the range of 4-15 μm and/or a D90 within the range of 10-30 μm, optionally wherein the size of the emulsion droplets is measured according to test A.

3. The composition according to claim 1, wherein the vegetable fat is chosen from the group consisting of coconut fat, palm fat, cacao fat, illipe fat, shea fat, palm kernel fat and mixtures thereof, or interesterified blends of vegetable oils and fats.

4. The composition according to claim 1, further comprising an emulsifier and/or a hydrocolloid, optionally wherein the amount of emulsifier is from 0.02-2% (w/w), optionally wherein the amount of hydrocolloid is from 0.02-1% (w/w).

5. The composition according to claim 1, further comprising maltodextrin, wherein the amount of maltodextrin is 0.5-20% (w/w).

6. The composition according to claim 1, wherein the rapeseed protein comprises 40-65% (w/w) cruciferins and 35-60% (w/w) napins, or wherein the rapeseed protein comprises 80-100% (w/w) cruciferins and 0-20% (w/w) napins, or wherein the rapeseed protein comprises 0-20% (w/w) cruciferins and 80-100% (w/w) napins, wherein the sum of cruciferins and napins is not exceeding 100% (w/w).

7. The composition according to claim 1, wherein the amount of rapeseed protein is from 0.1-10% (w/w), wherein the amount of vegetable fat is from 1-20% (w/w), wherein the amount of sucrose is from 5-25% (w/w) and further comprising maltodextrin with an amount of 3-20%.

8. The composition according to claim 1, wherein the amount of rapeseed protein is from 0.1-10% (w/w), wherein the amount of vegetable fat is from 20-40% (w/w), wherein the amount of sucrose is from 1-10% (w/w) further comprising maltodextrin with an amount 0.5-10%.

9. The composition according to claim 1, wherein the composition is in frozen form, a powder form, liquid form, or in the form of a whipping cream.

10. A method for preparation of a composition comprising rapeseed protein, a vegetable fat having a solid fat content of 20-90% (w/w) at 5° C., sucrose and water, comprising:
a) preparing an emulsion with the rapeseed protein, the vegetable fat, the sucrose and the water using high shear, resulting in an emulsion an oil-in-water emulsion, wherein the size of the emulsion droplets has a D50 within the range of 2-30 μm and/or a D90 within the range of 10-50 μm;
b) optionally pasteurizing the oil-in-water emulsion;
c) homogenizing the oil-water-emulsion at a pressure from 100 to 500 bar; and
d) cooling down the homogenized oil-in-water emulsion to a temperature between 0° C. and 20° C. for a time period of at least 1 hour.

11. The method according to claim 10, wherein a) comprises using a hydrocolloid and/or an emulsifier.

12. The method according to claim 10, further comprising freezing and aerating the composition resulting from d) for provision of an ice cream.

13. The method according to claim 10, further comprising whipping the composition resulting from d) for provision of a whipped cream.

14. A product comprising the composition according to claim 1, for manufacture of an ice cream or a whipped cream.

15. A food product comprising the composition according to claim 1, wherein the food product is an ice cream or a whipped cream.
